(19) United States
(12) Patent Application Publication
(10) Pub. No.: US 2023/0020608 A1
(43) Pub. Date: Jan. 19, 2023

(54) GAS TURBINE ENGINE FAN PLATFORM

(71) Applicant: General Electric Company, Schenectady, NY (US)

(72) Inventors: Nitesh Jain, Bangalore (IN); Raghuveer Chinta, Bangalore (IN); Nicholas Joseph Kray, Mason, OH (US); Wendy Wenling Lin, Montgomery, OH (US)

(21) Appl. No.: 17/375,433

(22) Filed: Jul. 14, 2021

(51) Int. Cl. F01D 5/28

(52) U.S. Cl. CPC F01D 5/282; F05D 2220/32; F05D 2240/30; F05D 2230/23

(57) ABSTRACT

A fan platform for gas turbine engine is provided. The fan platform incudes a body portion and a flow path surface coupled to the body portion. The body portion and the flow path surface define at least a portion of a flow path extending through the engine. The body portion and/or the flow path surface include an impact region including hybrid composite plies including one or more metallic tows. A gas turbine engine including the fan platform and methods for forming the fan platform are also disclosed.

The present subject matter relates generally to gas turbine engine fan platforms, and more particularly, to fan platforms having improved strength under high impact loads.

### BACKGROUND

Known fan assemblies include a plurality of circumferentially-spaced apart fan blades that extend radially outwardly from a rotor or disk. Each fan blade includes an airfoil section and with at least certain fan blades an integral dovetail root section. The dovetail root section is received in a complimentarily configured dovetail slot formed in the rotor. Fan assemblies can include a fan platform extending between adjacent fan blades. Fan platforms can be formed from composite materials. The inventors of the present disclosure have found, however, that such composite fan platforms may be susceptible to foreign object damage (FOD) such as damage from ingestion of foreign objects such as large birds and hailstones. Accordingly, the inventors of the present disclosure have found that there is a need for a fan platform that has improved damage tolerance under high impact loads.

### BRIEF DESCRIPTION OF THE DRAWINGS

A full and enabling disclosure of the preferred embodiments, including the best mode thereof, directed to one of ordinary skill in the art, is set forth in the specification, which makes reference to the appended FIGS., in which:

FIG. 1 is a schematic illustration of an exemplary gas turbine engine;

FIG. 2 is an enlarged schematic illustration of a fan assembly included with the engine shown FIG. 1;

FIG. 3 is a perspective view of a fan platform and a truncated fan blade included in the fan assembly shown in FIG. 2;

FIG. 4 is a perspective view of the fan platform shown in FIG. 3 and separated from the fan blade;

FIG. 5 illustrates a composite ply having metallic fibers in accordance with aspects of the present subject matter; and

FIG. 6 depicts a method of forming a fan platform in accordance with aspects of the present subject matter.

Repeat use of reference characters in the present specification and drawings is intended to represent the same or analogous features or elements of the present disclosure.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints. In embodiments, the use of the term “about” in conjunction with a numerical value is intended to refer to within twenty percent (20%) of the stated numerical value.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

A fan platform for a gas turbine engine is generally provided. The fan platform includes a body portion and a flow path surface coupled to or formed integrally with the body portion. The body portion and flow path surface define at least a portion of a flow path extending over the engine, through the engine, or both. The body portion and flow path surface are fabricated from a composite material and include one or more impact regions having a plurality of hybrid composite plies containing one or more metallic fiber tows. The fan platform, including the impact region(s), has improved strength and/or tolerance under higher impact loads, such as hail stone and bird ingestion loads. The embodiments generally provided herein may further enable the fan platform to withstand certain high impact loads without failing.

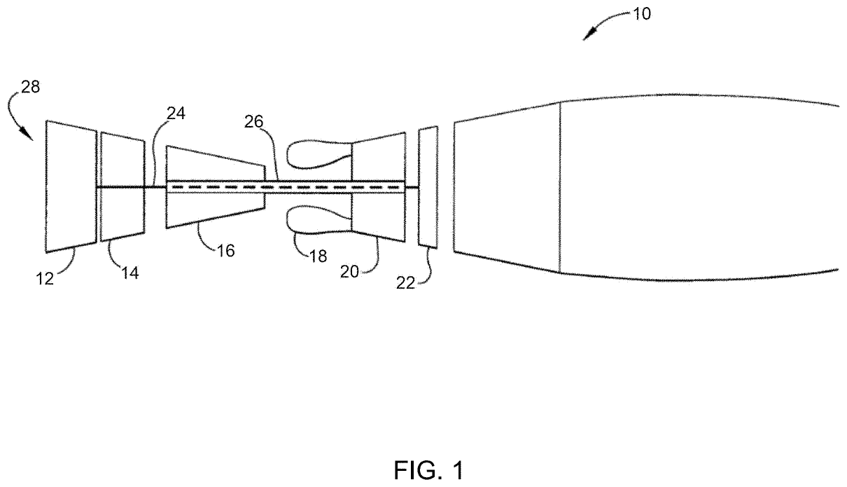

FIG. 1 is a schematic illustration of an exemplary gas turbine engine 10. Engine 10 includes a fan assembly 12 and a turbomachine, the turbomachine including in serial flow order a compressor, a combustion section or combustor assembly 18, and a turbine. More specifically, the turbomachine includes a low pressure compressor 14, a high pressure compressor 16, the combustor assembly 18, a high pressure turbine 20, and a low pressure turbine 22 arranged in a serial, axial flow relationship. Fan assembly 12, low pressure compressor 14 and low pressure turbine 22 are coupled by a first shaft 24, and high pressure compressor 16 and high pressure turbine 20 are coupled by a second shaft 26.

In operation, air flows through fan assembly 12 and low pressure compressor 14 from an upstream side 28 of engine 10. In the exemplary embodiment, a portion of the airflow exiting fan assembly 12 is delivered to low pressure compressor 14 while the remaining airflow exiting fan assembly 12 bypasses low pressure compressor 14 for various uses about engine 10 and aircraft (not shown). Compressed air is supplied from low pressure compressor 14 to high pressure compressor 16. Compressed air is then delivered to combustor assembly 18 where it is mixed with fuel and ignited. Combustion gases are channeled from combustor assembly 18 to drive high pressure turbine 20 and low pressure turbine 22.

It will be appreciated, however, that the exemplary gas turbine engine 10 depicted in FIG. 1 is by way of example only. In other exemplary embodiments, the gas turbine engine 10 may be configured in any other suitable configuration, e.g., having a fixed-pitch or variable pitch fan assembly 12, a high-bypass ration fan assembly 12, a geared or direct drive fan assembly 12, an open rotor configuration or a closed rotor configuration (e.g., including an outer nacelle), etc. Further the gas turbine engine 10 may include any suitable number or arrangement of shafts, spools, compressors, turbines, etc.

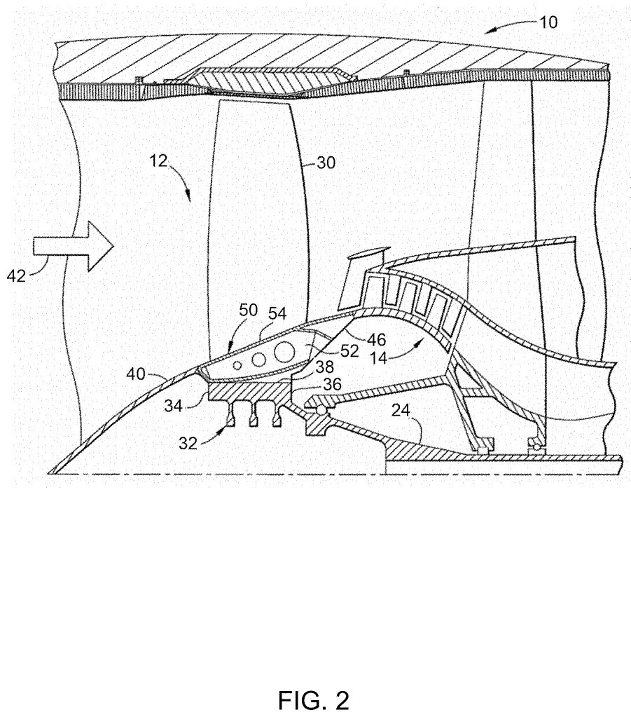

FIG. 2 is an enlarged schematic illustration of fan assembly 12. Fan assembly 12 includes a plurality of fan blades 30 that are circumferentially-spaced around rotor disk 32. Rotor disk 32 has axially-spaced apart upstream and downstream sides 34 and 36, respectively that are separated by a radially outer surface 38. Rotor disk 32 is coupled to first shaft 24. A conical spinner 40 is coupled to rotor disk upstream side 34 to define a substantially aerodynamic flow path boundary for air flow 42 entering fan assembly 12. Low pressure compressor 14 is downstream from fan assembly 12 and includes a spool 46 that is coupled to downstream side 36 of rotor disk 32.

Fan assembly 12 also includes a plurality of discreet fan platforms 50 that are each positioned between adjacent fan blades 30. Fan platform 50 extends substantially over radially outer surface 38 and each fan platform 50 includes a body 52 and a radially outer flow path surface 54 that extends substantially from conical spinner 40 to spool 46. Flow path surface 54 defines a substantially aerodynamic flow path surface for air flow between adjacent fan blades 30 and from conical spinner 40 over the remaining portion of the gas turbine engine, through the gas turbine engine (e.g., to low pressure compressor 14), or both. The flow path surface 54 may be coupled to the body 52 or formed integrally with the body 52 as a single monolithic component.

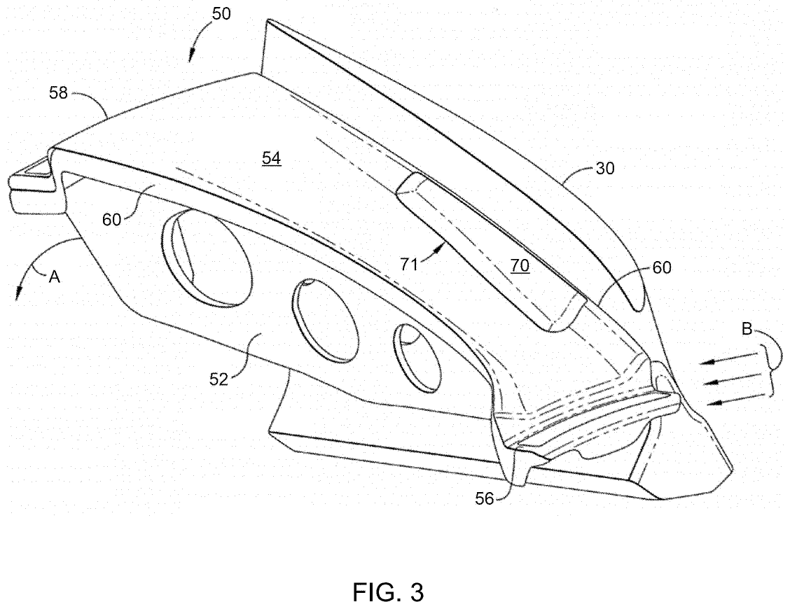

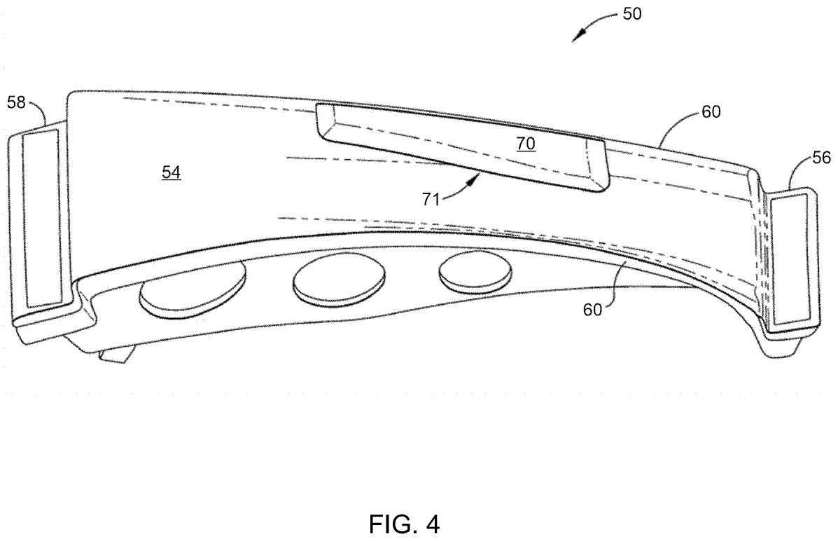

FIG. 3 is a perspective view of fan platform 50 coupled within fan assembly 12 adjacent a fan blade 30 that is truncated for clarity. FIG. 4 is a perspective view of the fan platform 50 removed from fan assembly 12. Fan platform 50 has an upstream end 56 and a downstream end 58. Frangible side edges 60 abut fan blades 30 and are crushable to permit continued rotation of fan blade 30 without causing damage to fan blade 30, in the event a foreign object impacts fan blade 30.

Fan platform 50 is fabricated from a lightweight composite material. In an exemplary embodiment, fan platform 50 is fabricated from carbon fiber using a resin transfer molding process. Composite materials generally have desirable fatigue characteristics, but such materials may be relatively brittle and lack desired impact or erosion durability. Accordingly, to facilitate enhancing the impact resistance and durability of fan platform 50, at least a portion of the body 52, the flow path surface 54, or both include an impact region 70 comprising one or more hybrid composite plies containing metallic fiber tows.

Sizing and placement of impact region 70 is variably selected based on a direction of fan rotation, indicated by arrow A, and based on estimated trajectories of incoming hailstones or other foreign objects, as indicated by arrows B and as described in more detail below. For example, rotation of fan blades 30, combined with probable trajectories of incoming hailstones or other foreign objects, enables at least some areas on flow path surface 54 to be identified as being at an increased or reduced risk of impact. For areas identified as being at an increased risk, such areas can be fabricated with one or more hybrid composite plies including metallic fiber tows. These considerations allow for placement of the impact region 70, such that impact region 70 is provided in areas of greatest vulnerability, such as along an upstream portion 71 of fan platform 50 as indicated by the placement of impact region 70 in FIG. 3.

In an embodiment, impact region 70 is positioned adjacent frangible edge 60 and closer to upstream end 56 than to downstream end 58 such that an area of flow path surface 54 identified as being more vulnerable to a foreign object impact is substantially formed from hybrid composite plies including metallic fiber tows. Accordingly, impact region 70 provides impact durability to flow path surface 54, without significantly affecting frangibility of the frangible edge 60. In other embodiments, substantially all of the flow path surface 54 can include the impact region 70 (not shown). For example, in certain embodiments, it is contemplated that the flow path surface 54 can be formed from a plurality of hybrid composite plies as described herein. Forming the flow path surface 54 utilizing the hybrid composite plies results in an impact region 70 capable of strengthening substantially the entire surface of the flow path surface 54, thus strengthening the flow path surface 54 upon high load impacts.

Impact region 70 includes one or more, such as a plurality, of hybrid composite plies. As used herein “hybrid composite ply” or “plies” refers to a ply having both metallic fiber tows and one or more other fiber tows formed from a different material, such as carbon fiber tows. The metallic fiber tows can be formed from any suitable metallic material. The metallic fiber tows can be woven and/or braided with one or more carbon fiber tows to form the hybrid composite plies. Indeed, any manner of weaving, braiding, looming, or layering may be used to include one or more metallic fiber tows in the hybrid composite plies used to form impact region 70. The metallic fiber tows can be oriented in one or more directions, such as at least two different direction in the hybrid composite plies. Suitable examples of metallic materials include, titanium, titanium-based alloys, nickel, nickel-based alloys, including nickel-based superalloys, iron-based alloys, and combinations thereof. In certain embodiments, the hybrid composite plies can include a plurality of metallic fiber tows formed from one or more or different types of metallic materials.

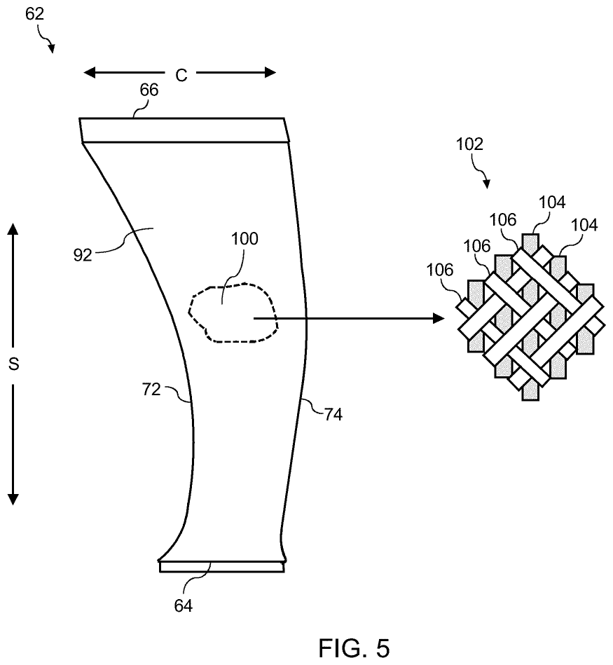

For example, referring now to FIG. 5, an exemplary airfoil 62 including a residual airfoil portion 92 and impact region 100 is shown. Again, the airfoil 62 defines a leading edge 72, trailing edge 74, airfoil tip 66, and root 64 as previously described. As shown, the impact region 100 includes a composite ply 102 having one or more metallic fibers 104 therein. For example, the composite ply 102 can include one or more metallic fibers 104 that are woven or braided with one or more composite fibers 106. While one pattern is shown, the disclosure is not so limited. Indeed, any manner of weaving, braiding, looming, or layering may be used to include one or more metallic fibers 104 in the composite plies 102 used to form impact regions 100.

The metallic fiber tows can have a diameter between about 2 μm and about 20 μm, such as from about 5 μm to about 15 μm. While the term “fibers” is used herein, the description is not so limited. Indeed, any type or shape of metallic fiber tow could be utilized herein. For instance, fibers or strips having various geometric diameters can be used. In embodiments, the fibers or strips can have rectangular, square, circular, and/or ovular diameters. In certain embodiments, the metallic fiber tows can include metallic strips having a certain thickness and width for particular application in the hybrid composite plies. For instance, when metallic strips are utilized, the metallic strips can have a thickness of up to about 0.05 inches, such as up to about 0.03 inches and a width of from about 0.1 inches up to about 0.5 inches.

In certain embodiments, the metallic fiber tows are formed from shape memory alloy (SMA) materials. A SMA material is generally an alloy capable of returning to its original shape after being deformed. For instance, SMA materials may define a hysteresis effect where the loading path on a stress-strain graph is distinct from the unloading path on the stress-strain graph. A SMA material may also provide varying stiffness, in a pre-determined manner, in response to certain ranges of stresses and temperatures. In the manufacture of an impact region 70 intended to change stiffness during operation of the fan platform 50, the impact region 70 may be formed to have one operative stiffness (e.g., a first stiffness) within a certain stress range and have another stiffness (e.g., a second stiffness) at another stress range, such as at a higher stress indicative of impact from a foreign object. Accordingly, utilization of SMA materials in the hybrid composite plies allows for the impact region 70 to deform upon impact but regain its shape after impact.

Non-limiting examples of SMA materials that may be suitable for use as metallic fiber tows described herein may include nickel-titanium (NiTi) and other nickel-titanium based alloys such as nickel-titanium hydrogen fluoride (NiTiHf) and nickel-titanium palladium (NiTiPd). However, it should be appreciated that other SMA materials may be equally applicable to the current disclosure. For instance, in certain embodiments, the SMA material may include nickel-aluminum based alloys, copper-aluminum-nickel alloys, or alloys containing zinc, zirconium, copper, gold, platinum, and/or iron. The alloy composition may be selected to provide the desired stiffness effect for the application such as, but not limited to, damping ability, transformation temperature and strain, the strain hysteresis, yield strength (of martensite and austenite phases), resistance to oxidation and hot corrosion, ability to change shape through repeated cycles, capability to exhibit one-way or two-way shape memory effect, and/or a number of other engineering design criteria. Suitable shape memory alloy compositions that may be employed with the embodiments of present disclosure may include, but are not limited to NiTi, NiTiHf, NiTiPt, NiTiPd, NiTiCu, NiTiNb, NiTiVd, TiNb, CuAlBe, CuZnAl and some ferrous based alloys. In some embodiments, NiTi alloys having transition temperatures between 5° C. and 150° C. are used. NiTi alloys may change from austenite to martensite upon cooling.

Moreover, SMA materials may also display superelasticity. Superelasticity may generally be characterized by recovery of large strains, potentially with some dissipation. For instance, martensite and austenite phases of the SMA material may respond to mechanical stress as well as temperature induced phase transformations. For example, SMAs may be loaded in an austenite phase (i.e., above a certain temperature). As such, the material may begin to transform into the (twinned) martensite phase when a critical stress is reached. Upon continued loading and assuming isothermal conditions, the (twinned) martensite may begin to detwin, allowing the material to undergo plastic deformation. If the unloading happens before plasticity, the martensite may generally transform back to austenite, and the material may recover its original shape by developing a hysteresis.

In embodiments, the fan platform 50, is formed at least partially from a ceramic matrix composite material. Composite materials may include, but are not limited to, metal matrix composites (MMCs), polymer matrix composites (PMCs), or ceramic matrix composites (CMCs). Composite materials generally comprise a fibrous reinforcement material embedded in matrix material, such as polymer, ceramic, or metal material. The reinforcement material serves as a load-bearing constituent of the composite material, while the matrix of a composite material serves to bind the fibers together and act as the medium by which an externally applied stress is transmitted and distributed to the fibers.

Exemplary CMC materials may include silicon carbide (SiC), silicon, silica, or alumina matrix materials and combinations thereof. Ceramic fibers may be embedded within the matrix, such as oxidation stable reinforcing fibers including monofilaments like sapphire and silicon carbide (e.g., Textron's SCS-6), as well as rovings and yarn including silicon carbide (e.g., Nippon Carbon's NICALON®, Ube Industries' TYRANNO®, and Dow Corning's SYLRAMIC®), alumina silicates (e.g., Nextel's 440 and 480), and chopped whiskers and fibers (e.g., Nextel's 440 and SAFFIL®), and optionally ceramic particles (e.g., oxides of Si, Al, Zr, Y, and combinations thereof) and inorganic fillers (e.g., pyrophyllite, wollastonite, mica, talc, kyanite, and montmorillonite). For example, in certain embodiments, bundles of the fibers, which may include a ceramic refractory material coating, are formed as a reinforced tape, such as a unidirectional reinforced tape. A plurality of the tapes may be laid up together (e.g., the composite plies) to form a preform component. The bundles of fibers may be impregnated with a slurry composition prior to forming the preform or after formation of the preform. The preform may then undergo thermal processing, such as a cure or burn-out to yield a high char residue in the preform, and subsequent chemical processing, such as melt-infiltration with silicon, to arrive at a component formed of a CMC material having a desired chemical composition.

Similarly, in various embodiments, PMC materials may be fabricated by impregnating a fabric or unidirectional tape with a resin (prepreg), followed by curing. For example, multiple layers of prepreg plies (e.g., the composite plies) may be stacked to the proper thickness and orientation for the part, and then the resin may be cured and solidified to render a fiber reinforced composite part. As another example, a die may be utilized to which the uncured layers of prepreg may be stacked to form at least a portion of the composite component. The die may be either a closed configuration (e.g., compression molding) or an open configuration that utilizes vacuum bag forming. The PMC material is placed inside of a bag and a vacuum is utilized to hold the PMC material against the die during curing. In still other embodiments, the fan platform 50 may be at least partially formed via resin transfer molding (RTM), light resin transfer molding (LRTM), vacuum assisted resin transfer molding (VARTM), a forming process (e.g., thermoforming), or similar.

Prior to impregnation, the fabric may be referred to as a “dry” fabric and typically comprises a stack of two or more fiber layers. The fiber layers may be formed of a variety of materials, non-limiting examples of which include carbon (e.g., graphite), glass (e.g., fiberglass), polymer (e.g., Kevlar®) fibers, and metal fibers. Fibrous reinforcement materials can be used in the form of relatively short chopped fibers, generally less than two inches in length, and more preferably less than one inch, or long continuous fibers, the latter of which are often used to produce a woven fabric or unidirectional tape. Other embodiments may include other textile forms such as plane weave, twill, or satin.

In one embodiment, PMC materials can be produced by dispersing dry fibers into a mold, and then flowing matrix material around the reinforcement fibers. Resins for PMC matrix materials can be generally classified as thermosets or thermoplastics. Thermoplastic resins are generally categorized as polymers that can be repeatedly softened and flowed when heated and hardened when sufficiently cooled due to physical rather than chemical changes. Notable example classes of thermoplastic resins include nylons, thermoplastic polyesters, polyaryletherketones, and polycarbonate resins. Specific examples of high performance thermoplastic resins that have been contemplated for use in aerospace applications include polyetheretherketone (PEEK), polyetherketoneketone (PEKK), polyetherimide (PEI), and polyphenylene sulfide (PPS). In contrast, once fully cured into a hard rigid solid, thermoset resins do not undergo significant softening when heated but, instead, thermally decompose when sufficiently heated. Notable examples of thermoset resins include epoxy, bismaleimide (BMI), and polyimide resins.

During manufacturing of the fan platform 50 described herein, one or more hybrid composite plies for forming the impact region 70 can be placed or incorporated with one or more composite plies and processed accordingly to provide the fan platform 50 as will be discussed further hereinbelow.

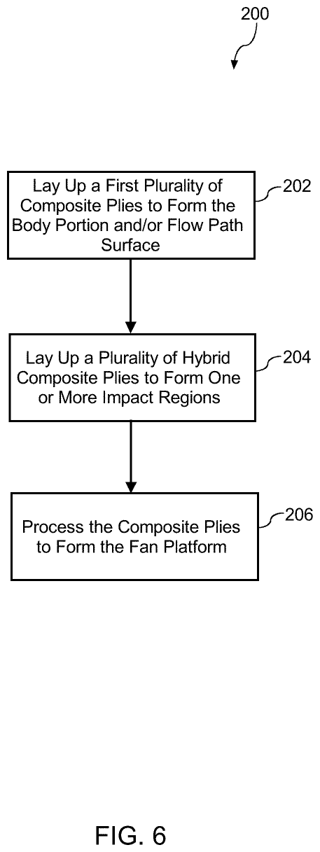

Referring now to FIG. 6, a method 200 of forming a fan platform is depicted according to aspects of the present subject matter. Particularly, the method 200 may be used to form various embodiments of the fan platform 50 as illustrated in FIGS. 2-4. The method 200 may include 202 laying up a plurality of composite plies to form the body, the flow path surface, or both the body and the flow path surface of the fan platform. The plurality of composite plies may include a composite material such as a CMC material. The composite plies may be laid up on a tool, mandrel, mold, or other suitable supporting device or surface. At 204, the method includes laying up a plurality of hybrid composite plies including metallic fiber tows therein to form one or more impact regions on or with at least a portion of the body, the flow path surface, or both the body portion and the flow path surface of the fan platform. For example, as one or more plies are laid, one or more hybrid composite plies including metallic fibers can be placed or sandwiched on top of each other or in between other composite plies in order to form impact regions along certain areas of the fan platform. One or more impact regions can be included in between one or more composite plies used to form the body and/or the flow path surface of the fan platform. The composite plies and hybrid composite plies may be laid up on a tool, mandrel, mold, or other suitable supporting device or surface.

Another step of the method 200 may include 206 processing the plurality of plies to form the fan platform. In one embodiment, processing the composite plies may include compacting the composite plies. In another embodiment of the method 200, processing the composite plies may include autoclaving the composite plies. In a still further embodiment of the method 200, processing the composite plies may include both compacting and autoclaving the composite plies. For instance, the composite plies may be compacted and then processed in an autoclave. The compaction may be performed at atmosphere, i.e., at room temperature and pressure. The autoclave cycle may impart stiffness to the final ply and/or layup assembly through complete drying and/or curing of the composite constituents and produces the final dimensions of the composite component through full consolidation of the plies and/or sub-assemblies.

Further, in embodiments in which the composite plies are processed in an autoclave, the composite plies may be autoclaved using soft and/or hard tooling. For instance, the composite plies may be autoclaved using metallic tooling, i.e., hard tooling, that is shaped to impart a desired shape to the frangible airfoil. As another example, the composite plies may be autoclaved using soft tooling such as a vacuum bag, e.g., the composite plies may be supported on a metal tool and then the composite plies and tool may be bagged and the air removed from the bag to apply pressure to and compact the composite plies before the composite plies are processed in a autoclave cycle. For instance, processing composite plies may include autoclaving the composite plies to form an autoclaved body. Further, another step may include firing the autoclaved body to form a fired body. Processing the composite plies may further include densifying the fired body to form the composite component. In certain embodiments, processing the composite plies may include at least one of melt infiltration or polymer infiltration and pyrolysis.

In embodiments in which the composite material is a CMC material, the autoclaved body may undergo firing (or burn-off) to form a fired body, followed by densification to produce a densified CMC component that is a single piece component, i.e., the component is a continuous piece of CMC material. For instance, after autoclaving, the component may be placed in a furnace to burn off any mandrel-forming materials and/or solvents used in forming the CMC plies and to decompose binders in the solvents, and then placed in a furnace with silicon to convert a ceramic matrix precursor of the plies into the ceramic material of the matrix of the CMC component. The silicon melts and infiltrates any porosity created within the matrix as a result of the decomposition of the binder during burn-off/firing; the melt infiltration of the CMC component with silicon densifies the CMC component. However, densification may be performed using any known densification technique including, but not limited to, Silcomp, melt-infiltration (MI), chemical vapor infiltration (CVI), polymer infiltration and pyrolysis (PIP), and oxide/oxide processes. In one embodiment, densification and firing may be conducted in a vacuum furnace or an inert atmosphere having an established atmosphere at temperatures above 1200° C. to allow silicon or another appropriate material or materials to melt-infiltrate into the component. Optionally, after processing, the composite component may be finish machined, if and as needed, and coated with one or more coatings.

Of course, the method 200 described with respect to FIG. 6 is provided by way of example only. As such, other known methods or techniques for compacting and/or curing composite plies, as well as for densifying a CMC component, may be utilized. Alternatively, any combinations of these or other known processes may be used and in any suitable order. Further, although the method 200 of FIG. 6 is described relative to fan platforms, the method 200 may also be used to form other composite components, such as turbine nozzle blades and turbine stator vanes and/or compressor blades and vanes including airfoils as exemplary composite components.

Further aspects of the disclosure are provided by the subject matter of the following clauses:

A fan platform for a gas turbine engine comprising: a body; and a flow path surface coupled to or formed integrally with the body and defining at least a portion of a flow path extending over the gas turbine engine, through the gas turbine engine, or both, wherein at least a portion of the body, at least a portion of the flow path surface, or both a portion of the body and a portion of the flow path surface are fabricated from a first composite material and comprise one or more impact regions comprising a plurality of hybrid composite plies comprising one or more metallic fibers, the one or more impact regions configured to strengthen the fan platform to withstand high impact loads.

The fan platform of any preceding clause, wherein the one or more metallic fibers comprise titanium, a titanium-based alloy, a nickel-based alloy, a nickel-based superalloy, an iron-based alloy, or combinations thereof.

The fan platform of any preceding clause, wherein the one or more metallic fibers have a diameter of from about 2 μm to about 20 μm.

The fan platform of any preceding clause, wherein the one or more metallic fibers comprise metallic strips having a thickness of less than about 0.03 inches and a width between about 0.12 inches and about 0.5 inches.

The fan platform of any preceding clause, wherein the one or more metallic fibers are woven with a second composite material to form the hybrid composite plies.

The fan platform of any preceding clause, wherein the one or more metallic fibers are braided with a second composite material to form the hybrid composite plies.

The fan platform of any preceding clause, wherein the one or more metallic fibers are oriented in two or more directions in the hybrid composite plies.

The fan platform of any preceding clause, wherein the one or more metallic fibers comprise shape memory alloy (SMA) material.

The fan platform of any preceding clause, wherein the SMA material comprises nickel-titanium (NiTi), nickel-titanium based alloys, or combinations thereof.

A gas turbine engine defining a central axis, the gas turbine engine comprising: a turbomachine comprising in serial flow order a compressor, a combustor, and a turbine; a fan rotatable with the turbomachine and comprising a plurality of circumferentially-spaced fan blades; and a fan platform extending between a pair of circumferentially-adjacent fan blades, the fan platform comprising: a body, and a flow path surface coupled to or formed integrally with the body and defining at least in part a flow path between the pair of circumferentially-adjacent fan blades, wherein at least a portion of the body, at least a portion of the flow path surface, or both a portion of the body and a portion of the flow path surface are fabricated from a first composite material and comprise one or more impact regions comprising a plurality of hybrid composite plies comprising one or more metallic fibers, the one or more impact regions configured to strengthen the fan platform to withstand high impact loads.

The gas turbine engine of any preceding clause, wherein the one or more metallic fibers comprise titanium, a titanium-based alloy, a nickel-based alloy, a nickel-based superalloy, an iron-based alloy, or combinations thereof.

The gas turbine engine of any preceding clause, wherein the one or more metallic fibers have a diameter of from about 2 μm to about 20 μm.

The gas turbine engine of any preceding clause, wherein the one or more metallic fibers comprise metallic strips having a thickness of less than about 0.03 inches and a width of from about 0.12 inches to s 0.5 inches.

The gas turbine engine of any preceding clause, wherein the one or more metallic fibers are woven with a second composite material to form the hybrid composite plies.

The gas turbine engine of any preceding clause, wherein the one or more metallic fibers are braided with second composite material to form the hybrid composite plies.

The gas turbine engine of any preceding clause, wherein the one or more metallic fibers are oriented in two or more directions in the hybrid composite plies.

The gas turbine engine of any preceding clause, wherein the one or more metallic fibers comprise SMA material.

The gas turbine engine of any preceding clause, wherein the SMA material comprises nickel-titanium (NiTi), nickel-titanium based alloys, or combinations thereof.

A method of forming a fan platform, the method comprising: laying up a plurality of composite plies to form a body, a flow path surface, or both the body and the flow path surface of the fan platform; laying up a plurality of hybrid composite plies containing one or more metallic fibers to form an impact region on or within the body, the flow path surface, or both the body and the flow path surface; and processing the plurality of composite plies and hybrid composite plies to form the fan platform.

The method of any preceding clause, wherein the one or more metallic fibers comprise titanium, a titanium-based alloy, a nickel-based alloy, a nickel-based superalloy, an iron-based alloy, or combinations thereof.

This written description uses exemplary embodiments to disclose the preferred embodiments, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A fan platform for a gas turbine engine comprising:
a body; and
a flow path surface coupled to or formed integrally with the body and defining at least a portion of a flow path extending over the gas turbine engine, through the gas turbine engine, or both,
wherein at least a portion of the body, at least a portion of the flow path surface, or both a portion of the body and a portion of the flow path surface are fabricated from a first composite material and comprise one or more impact regions comprising a plurality of hybrid composite plies comprising one or more metallic fibers, the one or more impact regions configured to strengthen the fan platform to withstand high impact loads.

2. The fan platform of claim 1, wherein the one or more metallic fibers comprise titanium, a titanium-based alloy, a nickel-based alloy, a nickel-based superalloy, an iron-based alloy, or combinations thereof.

3. The fan platform of claim 1, wherein the one or more metallic fibers have a diameter of from about 2 μm to about 20 μm.

4. The fan platform of claim 1, wherein the one or more metallic fibers comprise metallic strips having a thickness of less than about 0.03 inches and a width between about 0.12 inches and about 0.5 inches.

5. The fan platform of claim 1, wherein the one or more metallic fibers are woven with a second composite material to form the hybrid composite plies.

6. The fan platform of claim 1, wherein the one or more metallic fibers are braided with a second composite material to form the hybrid composite plies.

7. The fan platform of claim 1, wherein the one or more metallic fibers are oriented in two or more directions in the hybrid composite plies.

8. The fan platform of claim 1, wherein the one or more metallic fibers comprise shape memory alloy (SMA) material.

9. The fan platform of claim 8, wherein the SMA material comprises nickel-titanium (NiTi), nickel-titanium based alloys, or combinations thereof.

10. A gas turbine engine defining a central axis, the gas turbine engine comprising:
a turbomachine comprising in serial flow order a compressor, a combustor, and a turbine;
a fan rotatable with the turbomachine and comprising a plurality of circumferentially-spaced fan blades; and
a fan platform extending between a pair of circumferentially-adjacent fan blades, the fan platform comprising:
a body, and
a flow path surface coupled to or formed integrally with the body and defining at least in part a flow path between the pair of circumferentially-adjacent fan blades,
wherein at least a portion of the body, at least a portion of the flow path surface, or both a portion of the body and a portion of the flow path surface are fabricated from a first composite material and comprise one or more impact regions comprising a plurality of hybrid composite plies comprising one or more metallic fibers, the one or more impact regions configured to strengthen the fan platform to withstand high impact loads.

11. The gas turbine engine of claim 10, wherein the one or more metallic fibers comprise titanium, a titanium-based alloy, a nickel-based alloy, a nickel-based superalloy, an iron-based alloy, or combinations thereof.

12. The gas turbine engine of claim 10, wherein the one or more metallic fibers have a diameter of from about 2 μm to about 20 μm.

13. The gas turbine engine of claim 10, wherein the one or more metallic fibers comprise metallic strips having a thickness of less than about 0.03 inches and a width of from about 0.12 inches to s 0.5 inches.

14. The gas turbine engine of claim 10, wherein the one or more metallic fibers are woven with a second composite material to form the hybrid composite plies.

15. The gas turbine engine of claim 10, wherein the one or more metallic fibers are braided with second composite material to form the hybrid composite plies.

16. The gas turbine engine of claim 10, wherein the one or more metallic fibers are oriented in two or more directions in the hybrid composite plies.

17. The gas turbine engine of claim 10, wherein the one or more metallic fibers comprise SMA material.

18. The gas turbine engine of claim 17, wherein the SMA material comprises nickel-titanium (NiTi), nickel-titanium based alloys, or combinations thereof.

19. A method of forming a fan platform, the method comprising:
laying up a plurality of composite plies to form a body, a flow path surface, or both the body and the flow path surface of the fan platform;
laying up a plurality of hybrid composite plies containing one or more metallic fibers to form an impact region on or within the body, the flow path surface, or both the body and the flow path surface; and
processing the plurality of composite plies and hybrid composite plies to form the fan platform.

20. The method of claim 19, wherein the one or more metallic fibers comprise titanium, a titanium-based alloy, a nickel-based alloy, a nickel-based superalloy, an iron-based alloy, or combinations thereof.
